(19) United States
(12) Patent Application Publication
(10) Pub. No.: US 2024/0279977 A1
(43) Pub. Date: Aug. 22, 2024

(54) SLIDING DOOR FOR USE AS AN ESCAPE AND RESCUE DOOR IN A BUILDING, AND METHOD FOR OPERATING A SLIDING DOOR AS AN ESCAPE AND RESCUE DOOR

(71) Applicant: Inventio AG, Hergiswil (CH)

(72) Inventors: Jonas Vonaesch, Luzern (CH); Max Schwitalla, Ebikon (CH); Florian Trosch, Erlenbach ZH (CH)

(21) Appl. No.: 18/560,117

(22) PCT Filed: May 4, 2022
(86) PCT No.: PCT/EP2022/061904

§ 371 Date: Nov. 10, 2023

(30) Foreign Application Priority Data
May 17, 2021 (EP) 21173991.7

(51) Int. Cl. E05F 15/72; E05F 15/73

(52) U.S. Cl. CPC E05F 15/72; E05F 15/73; E05Y 2201/422; E05Y 2400/40; E05Y 2800/252; E05Y 2900/134

(57) ABSTRACT

A sliding door for use as an escape and rescue door has a drive actuated by a door control device, wherein the door control device receives signals from a sensor system including a plurality of sensors and, optionally, from a higher-order central station. The door control device actuates the drive to perform a standard opening during a standard operation when the received sensor signals indicate at least one opening condition as satisfied and the sensor system signals an approach to the sliding door. The door control device switches to emergency operation when the received sensor signals indicate an emergency, wherein the door control device actuates the drive to perform an emergency opening in an emergency operation, irrespective of whether the received sensor signals indicate the at least one opening condition as satisfied, when at least one sensor signals an approach to an inner side of the sliding door.

### FIELD

The technology described herein relates to a sliding door for use as an escape and rescue door in a building along with a method for operating a sliding door as an escape and rescue door.

### BACKGROUND

A sliding door can be closed and opened by moving it laterally in a closing and opening direction. The closing and opening direction can be aligned approximately parallel to a center plane of the sliding door. Due to this linear movement, the sliding door requires little space; to open it can be moved, for example, into a recess of a building wall. Then, the sliding door can be almost invisible in an open state.

For example, WO 2020/182513 A1 describes a possible design of a sliding door.

During an emergency situation, an escape and rescue door should be able to be opened from a side from which persons need to leave a room or zone in the emergency situation. With reference to the room or zone, such side is also referred to in the following in connection with formulations such as “inner side” or “from the inside”; correspondingly, an opposite side is referred to as “outer side” or “from the outside.” An escape direction can be defined in a building plan or evacuation plan, for example, from the inside to the outside.

The escape and rescue door should open outward, since this allows it to be opened by pressure from the inside. Even in a panic situation, if a plurality of persons are approaching the escape and rescue door, this prevents them from blocking an opening movement of the escape and rescue door. The escape and rescue door can have a special panic lock. With a panic lock, a locking of the escape and rescue door is unlocked by actuating an internal latch or trigger. Then, the door can be opened.

Since sliding doors open and close transversely to an escape direction, pressure from the inside can cause the door panel to wedge in the frame. The opening movement of the sliding door is not intuitive in a panic situation. Until now, it was therefore assumed that sliding doors could not meet the requirements for escape and rescue doors and that the possible uses of sliding doors were therefore limited.

### SUMMARY

Among other things, there can be a need for a sliding door with extended application possibilities, in particular for use as an escape and rescue door, for example, and a method for operating a sliding door as an escape and rescue door.

Such a need can be met by a sliding door for use as an escape and rescue door and by a method for operating a sliding door as an escape and rescue door according to the advantageous embodiments defined and described in the description.

According to a first aspect, a sliding door for use as an escape and rescue door is presented, wherein the sliding door has a drive actuated by a door control device of the sliding door. Thereby, the door control device is configured to receive signals from a sensor system comprising a plurality of sensors and, optionally, from a higher-order central station. The door control device is designed to actuate the drive to perform a standard opening of the sliding door during a standard operation if the sensor system or the central station signals at least one opening condition as satisfied and the sensor system signals an approach to the sliding door. The door control device is further designed to switch to emergency operation if the sensor system or the central station signals an emergency, wherein the door control device is further designed to actuate the drive to perform an emergency opening in emergency operation irrespective of whether the sensor system or the central station signals the at least one opening condition as satisfied if at least one sensor of the sensor system signals an approach to an inner side of the sliding door.

According to a further aspect, a method for operating a sliding door as an escape and rescue door is presented, wherein during a standard operation a drive of the sliding door is actuated in response to signals from a sensor system of the sliding door comprising a plurality of sensors and, optionally, from a higher-order central station to perform a standard opening of the sliding door if the sensor system or the central station signals at least one opening condition as satisfied and the sensor system signals an approach to the sliding door, wherein there is a switch to emergency operation if the sensor system or the central station signals an emergency, wherein the drive is actuated to perform an emergency opening in emergency operation irrespective of whether the sensor system or the central station signals the at least one opening condition as satisfied, if at least one sensor of the sensor system signals an approach to an inner side of the sliding door.

A sliding door can have a door panel mounted so that it can move linearly. The door panel can be moved or shifted sideways to open and close the sliding door. A drive of the sliding door can open and close the sliding door automatically. The drive can open the sliding door in response to an opening signal and close it in response to a closing signal. The opening signal can be provided by a door control device of the sliding door. The door control device can be referred to as the door controller. The door control device can be an electrical device and receive, process and output signals.

The drive can be electric, for example. For example, the drive can be a belt drive with which a drive motor is arranged on a frame of the sliding door and moves a drive belt coupled to the door panel. Likewise, the drive motor can be arranged on the door panel and move the belt coupled to the frame. The sliding door can have an additional locking mechanism. The locking mechanism can also be actuated by the door control device. In particular, the locking mechanism can lock automatically when the sliding door is closed and can be unlocked by an unlock signal to open the sliding door.

A sensor system can have one or more sensors directed toward an inner side of the sliding door, i.e., sensors capable of detecting physical parameters in a room adjacent to the inner side of the sliding door. The sensor system can also have one or more sensors directed toward an outer side of the sliding door. Signals from the sensor system may be read and evaluated by the door control device. The sensor system can be part of the sliding door. The sensor system or individual sensors can also be part of a sensor system of a building. The sensor system can detect an approach of, for example, a person to the sliding door and provide, for example, an approach signal to report the approach. For this purpose, the sensor system can use one or more sensors to detect physical parameters that change in a characteristic manner when such an approach is made. For example, moving shadows, light beams and laser pointers can be recognized as moving but not approaching.

A higher-order central station can be, for example, a server of the building. The higher order central station can also be a remote control center or service center. The higher-order central station can be, for example, a fire alarm system of the building. An emergency can be, for example, a fire alarm, bomb alarm, poison alarm or CBR alarm, earthquake alarm, sandstorm alarm or tsunami alarm. A message about the emergency can be provided automatically by the higher-order central station. Due to the emergency message, emergency operation can then activate, even if the reported emergency involves a remote part of the building. It can also be used to respond to emergencies that the sliding door itself cannot recognize, for example because there are no corresponding sensors.

For example, the sliding door can be a door of a home, a front door of a house, a door of an office, a room or intermediate door of the home, a hotel or a co-working space. A room divider or a garden gate can also be designed as such a sliding door. During a standard operation, the door control device can actuate the drive for a standard opening of the sliding door if at least one opening condition is satisfied and the sensor system reports the approach from the inner side or an approach from an outer side of the sliding door.

The sliding door can have its own power supply. The power supply can provide electrical power to the sliding door for a minimum period of time after a power failure. The power supply can be a battery, for example. Due to the power supply, the sliding door can continue to open and close, electrically driven, after the power failure. For example, the minimum period of time can be one day. Thereby, the power supply can ensure a minimum number of openings. For example, the minimum number can be greater than a maximum allowed number of persons in the home, house, room or space behind the sliding door. The power failure can also be reported to a control center.

The sliding door can have a cooling device for sensitive components. The cooling device can be referred to as a heat protection device. For example, the heat protection device can passively and/or actively protect the drive motor, power supply, and/or door control device from the heat of a fire. The heat protection device can comprise heat-resistant and insulating material. The heat protection device can also have a cooling medium. The cooling medium can cool down the sensitive components. For example, the cooling medium can be a compressed or liquid gas. The gas can be, for example, carbon dioxide or nitrogen.

The opening condition can be, for example, an authorization to enter the room separated by the sliding door; the room is an example of an access-restricted zone in a building. Authorization can be proven, for example, by a matching key, a correctly entered code, a correctly encoded transponder and/or a correct optoelectronically readable code. Likewise, authorization can be proven by a biometric method, such as facial recognition, voice recognition and/or fingerprint recognition. Different methods can be combined to secure the opening condition. For example, facial recognition and reading of a transponder can be combined.

The opening condition can also be used to ensure that an approach is recognized, in order to avoid false openings. In particular, on the inner side, a direction of approach can be checked, in order to prevent the sliding door from opening when a person walks past the sliding door approximately parallel to the sliding door. Thus, the approach can be recognized if a person moves towards the sliding door. The approach can be distinguished by the sensor system from a passing by of the sliding door. Even with a person with authorization, a distinction can be made between approaching and passing in standard operation.

The standard opening can be performed if the approach is reported and the opening condition is also present. In the case of a contactless proof of authorization, the authorization can be queried after the approach has been recognized. For example, in the case of a home, the opening of a door caused by the approach of a pet or an unauthorized small child can be prevented. Alternatively, the authorization can have already been queried before the approach is recognized. For example, the radio range for querying authorization can be greater than the detection range of the sensor system.

Emergency operation of the sliding door can be required if an emergency occurs in the home or office. In emergency operation, a contactless exit from the home or office can be required. The sliding door opens in emergency operation without any additional condition, if the approach from the inner side is recognized. In emergency operation, the sliding door will thus open even for the small child or pet. Thus, an emergency opening from the inner side can be performed without proof of authorization. By actuating the drive preferably already upon an approach, the sliding door starts to open before the sliding door is reached. In contrast, authorization can still be required even in emergency operation upon an approach from the outer side. However, in emergency operation, additional persons or groups of persons may have the authorization to open. For example, in emergency operation, additional keys, codes, transponders or optoelectronically readable codes can be enabled for the fire department, rescue service and/or police.

The standard opening can be performed at a preset standard opening speed. Moreover, a standard closing can be performed at a preset standard closing speed, in order to prevent persons and/or objects from becoming trapped. The emergency opening can be performed at an emergency opening speed. The emergency opening speed can be greater than the standard opening speed. For example, the sliding door can be opened to 80 percent of its maximum opening width in less than three seconds. The sliding door can also be opened within the three seconds, for example, to an opening width of at least 900 millimeters. In this way, the sliding door can rapidly reach a minimum opening width in emergency operation.

If an emergency operation is activated, an emergency message can be sent to the higher-order central station, in order to document the activation of emergency operation. Likewise, the emergency message can be sent to mobile devices of residents of the home or those working in the office, in order to provide information about the activation of emergency operation. The emergency message can also be stored on a server and downloaded there from a user application.

If an emergency operation is activated, a recording of sensor data from the sensor system can be started, in order to document a history of the emergency. A video recording can also be started. Sensor data and/or video data may also be sent to the mobile devices of residents and/or the central station and/or deposited on the server. The sensor data and/or video data may be sent and/or stored in encrypted form.

When switching to emergency operation, the sensitivity of the sensor system can be increased from a standard sensitivity in standard operation to an emergency sensitivity. For example, the detection range of the sensor system can be increased. Thus, the detection range of the sensor system can be larger in emergency operation than in standard operation. Thus, the approach can be recognized earlier. By recognizing the approach earlier, the sliding door can already be fully open when the person reaches the sliding door. The detection range can be increased, in particular for active sensors, by increasing a maximum reception time for receiving a reflection. Alternatively or additionally, threshold values of the characteristic parameters for recognizing the approach may be lowered, so that, in emergency operation, even a small object approaching that would be ignored in standard operation, such as a pet, can trigger the emergency opening.

The door control device can switch to emergency operation if the sensor system signals flames and/or smoke on the inner side. The sensor system can comprise a smoke detector and/or flame detector. Alternatively or additionally, the door control device can access at least one smoke detector and/or flame detector of the home or office; for example, the door control device receives a signal from the smoke and/or flame detector via an electrical line. In the event of flames and/or smoke, rapid escape from the home or office can be required. Therefore, in emergency operation, the sliding door opens when approached from the inner side without any additional opening condition.

When the sliding door is open, the door control device can actuate the drive for emergency closing if the sensor system signals flames and/or smoke on the inner side and no approach is reported. If the sliding door is open, smoke can flow from the home or office into the rest of the building. Likewise, a fire can be supplied with oxygen when the sliding door is open. The escape of smoke can be prevented or slowed down by means of emergency closing. Furthermore, the supply of oxygen can be interrupted. In addition, flames are stopped by a sliding door that is closed. For example, the sliding door can be closed at the emergency closing speed during emergency closing, in order to minimize smoke leakage. For example, the sliding door can be closed in less than three seconds. The sliding door can thus be used as a fire door. An emergency opening upon an approach works even after emergency closing.

The door control device cannot or should not actuate the drive if the sensor system signals smoke on the inner side and the approach is signaled exclusively by a proximity sensor of the sensor system. For example, a proximity sensor can be a time-of-flight or TOF sensor. The time-of-flight sensor emits light pulses and receives reflections of the light pulses. The transit time between sending and receiving results in a distance. An approach can be recognized if the measured distance decreases over a plurality of measurements. Smoke can interfere with the proximity sensor, since it can reflect the light pulses. The proximity sensor can falsely signal an approach if the smoke is approaching and reflects the light pulses at an ever decreasing distance from the proximity sensor.

In emergency operation, the door control device can further actuate an operating element on the inside of the sliding door and actuate the drive if the operating element signals an operation. An operating element can be an electric switch or pushbutton. For example, the operating element can depict a pictogram for an emergency exit. The operating element can have emergency exit lighting. The emergency exit lighting can visually highlight the escape and rescue door. The emergency exit lighting can also visually highlight a frame of the sliding door. The operating element can comprise a touchscreen, for example. In emergency operation, an icon can be displayed on the touchscreen as an operating element for emergency opening. In emergency operation, the entire touchscreen can also be used as an operating element, regardless of the icon displayed. In standard operation, the touchscreen can depict an alternative opening pictogram. The operating element can be integrated into an inner door panel of the sliding door or arranged on the inner side of the sliding door. The operating element can also be a mechanical pushbutton or trigger. The operating element can be moved out of a plane of the door panel when activated. Thus, the protruding operating element can be felt even in thick smoke. The operating element can be mechanically coupled to the locking mechanism of the sliding door. The operating element can be pressed to unlock the locking mechanism.

The door control device can actuate the drive for emergency closing after a predefined opening time following the emergency opening. The drive can be actuated to hold the sliding door open for a predefined opening time after emergency opening and then to close it. For example, the opening time can be five seconds. Due to the opening time, a person has enough time to leave the home or office. After leaving, the sliding door is automatically closed again in order to prevent unauthorized entry into the home or office and/or to prevent or at least limit the spread of smoke, fire and oxygen.

The door control device can switch to emergency operation if an application of force on the inner side of the sliding door greater than a threshold value is signaled. The door control device can then actuate the drive to perform the emergency opening if a renewed or prolonged application of force to the inner side is signaled. An emergency that triggers emergency operation can possibly remain undetected. When escaping from the home or office, a person can press against the closed sliding door with great force, for example in panic or due to a strong desire to escape. Since the sliding door opens sideways, the sliding door cannot be pushed away in an escape direction. In order to prevent the sliding door from jamming, the emergency opening can be initiated. The pressure on the inner side can be detected, for example, by a pressure sensor arranged between a door panel and a frame of the sliding door.

The door control device can switch to emergency operation and also actuate the emergency opening if the drive signals the application of force. A mechanism of the sliding door can be moved slightly sideways by the application of force from the inner side. Thereby, the drive can be moved in the process. Thus, the pressure can also be detected by the drive of the sliding door. If the emergency has caused a power failure, the sliding door can also be pushed open manually from the inner side.

The sliding door can have an outer panel and an inner panel coupled by the mechanism. In particular, the outer panel and the inner panel may be movably supported by the mechanism perpendicular to the opening direction of the sliding door, in order to reduce the thickness of the sliding door upon opening. A force applied to the outer panel can be blocked by the mechanism.

The door control device can switch to emergency operation if the sensor system signals continuous loud screaming on the inner side. The sensor system can have at least one microphone. Alternatively or additionally, the door control device can access at least one microphone in the home or office. Loud screaming can be a sign of an emergency. Thereby, panic screams or alarm calls can be distinguished from baby cries, for example. The approach at the inner side can also be detected acoustically. For example, a running or fleeing person can be recognized acoustically from a great distance. Thus, the emergency opening can be initiated on a timely basis.

The door control device can switch to emergency operation if the sensor system signals a temperature on the inner side that is greater than a temperature threshold value. The sensor system can have at least one temperature sensor. Alternatively or additionally, the door control device can access at least one temperature sensor in the home or office. Excessive indoor temperature can be harmful to workers, residents and pets. A rapid exit from the home or office can be necessary to avoid heat damage. A sharp rise in internal temperature can indicate a fire. In order to avoid emergency operation due to solar radiation, a temperature threshold value can be dynamically adjusted to seasonal and/or weather-related fluctuations. In particular, a marked increase in the internal temperature above expectable values can be detected and emergency operation can be activated.

The door control device can actuate the drive for emergency opening in emergency operation if the higher-order central station signals an emergency opening command. For example, an emergency opening command can be given by an authorized building manager. By means of a remote-controlled emergency opening, the sliding door can be opened, for example, for the fire department, the rescue service or the police, so that they can get into the home or the office without having to break open the sliding door. When emergency operation is activated, the emergency opening can alternatively or additionally be triggered by a mobile device of the fire department, the rescue service or the police. An emergency operation can be a prerequisite for actuation by an external mobile device. This can require a special application, such as a fire department app. During emergency operation, any access by otherwise unauthorized persons can be documented.

The sliding door can have a cooling device for cooling major components. The door control device can activate the cooling device in emergency operation if the sensor system signals a temperature on the inner side greater than a temperature threshold value. The cooling device can actively cool the drive, the door control device and/or a power supply of the sliding door. Due to the active cooling, the sliding door can withstand high temperatures for prolonged periods of time. Due to the active cooling, the sliding door can be opened and closed even after prolonged exposure to temperature. The cooling device can cool the drive, the door control device and/or the power supply for at least 15 minutes, for example.

The sliding door can have a power supply. The power supply can be designed to provide electrical power to important components of the sliding door after a power failure. The power supply can be described as an emergency power supply. The power supply can supply the drive, the sensor system and the door control device. The power supply can be a battery large enough to provide power to the sliding door for a prolonged period of time. Due to the power supply, the sliding door can open and close automatically even in the event of a power failure. For example, the power supply can be large enough so that the sliding door can continue operating until a service technician can restore power within an agreed intervention time.

It should be noted that some of the possible features and advantages of the technology are described herein with reference to different embodiments of methods on the one hand and of devices on the other hand. A person skilled in the art will recognize that the features can be suitably combined, adapted, or replaced in order to arrive at further embodiments of the technology.

Embodiments of the technology will be described below with reference to the accompanying drawings, wherein neither the drawings nor the description are intended to be interpreted as limiting the technology.

### DESCRIPTION OF THE DRAWINGS

FIG. 1 shows a representation of a sliding door according to an exemplary embodiment; and

FIG. 2 shows a flowchart of a method for operating a sliding door according to an exemplary embodiment.

The drawings are merely schematic, and not to scale. The same reference signs indicate the same or equivalent features.

### DETAILED DESCRIPTION

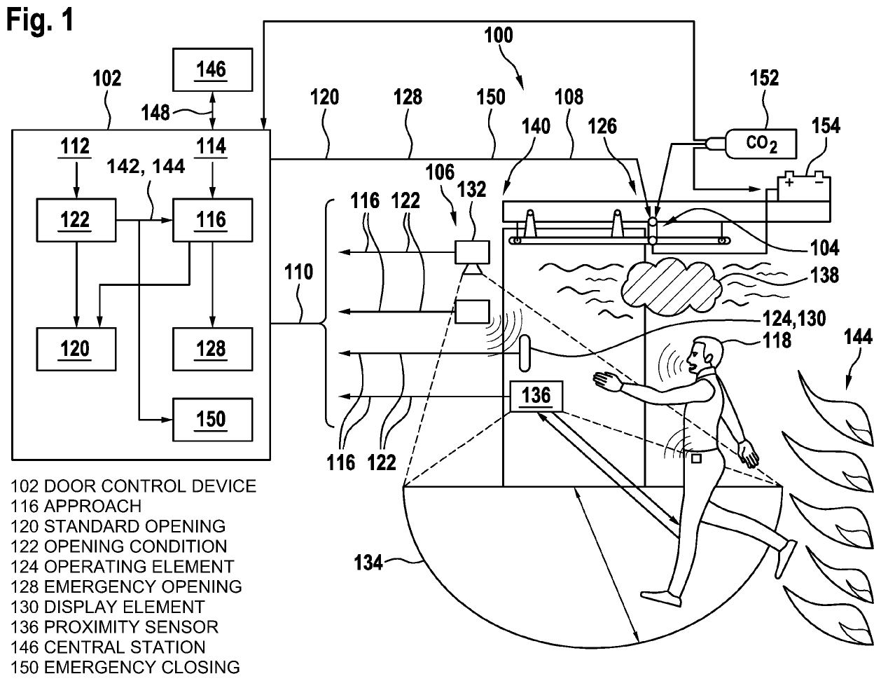

FIG. 1 shows a representation of a sliding door 100 according to an exemplary embodiment. The sliding door 100 has a door control device 102, a drive 104 and a sensor system 106 comprising at least one sensor. The sliding door 100 is a door of a home or a door of an office and is at the same time an escape and rescue door of the home or office. Thereby, the sliding door 100 can be arranged, for example, between a stairwell of a building and the home or office. The sliding door 100 is driven by the drive 104 and opens and closes automatically. The door control device 102 actuates the drive 104 via a drive signal 108. To actuate the drive 104, the door control device 102 evaluates sensor signals 110 from the sensor system 106.

The sliding door 100 or the door control device 102 can be operated during a standard operation 112 and an emergency operation 114. In standard operation 112, the sliding door 100 can be opened with a standard opening 120 upon an approach 116 of a person 118 to the sliding door 100, if at least one opening condition 122 is satisfied in addition to recognizing the approach 116. For example, checking the opening condition 122 can include verifying that a person approaching the sliding door 100 is authorized to pass. The standard opening 120 can also be requested via an operating element 124. Even then, the additional opening condition 122 can be required.

In emergency operation 114, the sliding door 100 is opened with an emergency opening 128 upon an approach 116 of a person 118 to an inner side 126 of the sliding door 100. No additional opening condition 122 is required for emergency opening 128 from the inner side 126. In the above example, this means that the sliding door 100 opens automatically during an emergency operation 114 even for persons who are not authorized to pass through the sliding door 100 during standard operation 112. Thereby, the approach 116 of the person 118 can be recognized using a plurality of different sensors of the sensor system 106. Thereby, for example, sensors that are used during standard operation 112 to monitor the criteria for the opening condition 122 may also be used during emergency operation 114, in order to reliably recognize the approach 116 of persons 118. For example, a sensor that is used during normal operation 112 to recognize what body size a person 118 approaching the sliding door 100 has in order to prevent the sliding door 100 from opening based on such information, for example, if a child or pet is approaching, may be used during emergency operation 114 to recognize persons 118 of any size and open the sliding door 100 in response. Due to the emergency opening 128, the sliding door 100 opens even before the person 118 reaches the sliding door 100.

The door control device 102 switches from standard operation 112 to emergency operation 114 if the sensor system 106 or a central station 146 signals an emergency 144.

In one exemplary embodiment, a display element 130 on the inner side 126 of the sliding door 100 is activated when the door is switched to emergency operation 114. The display element 130 is illuminated and depicts an emergency exit pictogram. The display element 130 can be a touch-sensitive display and can depict an additional operating element 124 of the sliding door 100. However, the display element 130 can also act as the additional operating element 124 of the sliding door 100 over the entire surface. The additional operating element 124 is provided in emergency operation 114 as a fallback level if the approach 116 is not recognized.

In one exemplary embodiment, the approach 116 at the inner side 126 of the sliding door 100 is recognized if at least one of the sensors of the sensor system 106 directed toward the inner side 126 reports the approach 116. For example, a camera 132 of the sensor system 106 can be pointed at a region 134 of the home or office in front of the inner side 126. The region 134 can be, for example, 1.5 meters from the inner side 126; in FIG. 1, the region 134 is shown as a semicircular area by way of example, and the person skilled in the art will recognize that the region 134 also extends in the vertical direction. If the person 118 enters the region 134, he or she is detected by the camera 132 and the approach 116 is reported. In emergency operation 114, the emergency opening 128 is then triggered without any further opening condition 122.

Likewise, a proximity sensor 136 can monitor the region 134. The proximity sensor 136 transmits light pulses, invisible to humans, into the region 134 and receives reflections of the light pulses from the region 134 if an object is arranged in the region 134. From the transit time of the light, the proximity sensor 136 calculates the distance to the object. If the object is not moving, the distance between successive light pulses remains constant and no approach 116 is reported. If the person 118 enters the region 134, the light is reflected off the person 118 and the distance between successive light pulses decreases. The approach 116 is then reported. In emergency operation 114, the emergency opening 128 is then triggered without any further opening condition 122.

In one exemplary embodiment, the sliding door 100 is adapted as a fire door of the home or office. Thereby, the proximity sensor 136 is ignored if smoke 138 is recognized on the inner side 126, since the smoke 138 reflects the light pulses like an object and the billowing smoke leads to falsely recognized approaches 116. This can prevent the sliding door 100 from being opened by the smoke 138 and the smoke 138 from escaping into the stairwell or hallway.

In one exemplary embodiment, upon an approach 116 of a person 118 at an outer side 140 of the sliding door 100, at least one opening condition 122 is required in both standard operation 112 and emergency operation 114. On the outer side 140, the opening condition 122 for the standard opening 120 can be, for example, an access authorization 142. In standard operation 112, the opening condition 122 can also be required upon an approach 116 at the inner side 126. However, upon an approach 116 at the inner side 126, a less stringent opening condition 122 can be required for the standard opening 120.

For example, access authorization 142 can be proven by touch via a matching key in a lock switch of the sensor system 106, or an authorized fingerprint on a fingerprint sensor of the sensor system 106. Likewise, access authorization 142 can be proven by a code, such as a correctly entered numeric code on a keypad of the sensor system 106.

Contactless access authorization 142 can be proven optically or electromagnetically. For example, a camera of the sensor system 106 directed toward the outer side 140 can detect a face of the person 118 and facial recognition can be performed. If the face is recognized as authorized, access authorization 142 can be present. The camera can also read an optically readable code, such as a QR code, a barcode, a data matrix or a color code. With a correct code, access authorization 142 can be proven.

Likewise, an antenna of the sensor system 106 can emit a radio wave signal. If the person 118 carries a correctly coded transponder, access authorization 142 can be proven. Thereby, the transponder can be an RFID chip, for example. Likewise, the transponder can be a mobile device, such as a smartphone or smartwatch with an authorized application.

A microphone of the sensor system 106 can be used to detect a voice of the person 118. A correctly recognized voice can serve as access authorization 142. Likewise, voice or melody recognition can be performed and a correctly reproduced audible code can serve as an access authorization 142.

In emergency operation 114, in one exemplary embodiment, additional access authorizations 142 are enabled, for example, for the fire department, rescue service and police. The fire department, ambulance service and police, for example, may have special transponders to identify themselves.

In one exemplary embodiment, at least on the inner side 126, an opening condition 122 consists of an approach 116 in the direction of the sliding door 100. Thereby, the direction of movement can be determined by the camera 132 and/or the proximity sensor 136. Thus, even when entering the region 134, walking past the sliding door 100 can be distinguished from walking toward the sliding door 100. This can prevent false openings of the sliding door 100.

In one exemplary embodiment, the sliding door 100 automatically switches from standard operation 112 to emergency operation 114 if an emergency 144 is recognized in the building or home or office.

The emergency 144 can be reported by a central station 146. The central station 146 can be a building controller. Likewise, the central station 146 can be a service center of an operator of the sliding door 100. For example, a fire alarm can be triggered by a fire alarm system of the building. Likewise, an earthquake alarm, bomb alarm and/or another alarm can be reported by the central station 146.

The emergency 144 can also be detected via the sensor system 106. For example, the camera 132 can detect flames, the light of a fire and/or smoke 138 in front of the inner side 126. In response to the recognition of flames, the light of a fire and/or smoke 138, the sliding door 100 automatically switches from standard operation 112 to emergency operation 114. In addition, a fire alarm can be sent to the central station 146.

In one exemplary embodiment, an emergency message 148 is sent to the central station 146 and/or a user portal if emergency operation 114 is activated. Thus, residents of the home or users of the office can be informed even if they are not in the home or office. Likewise, each emergency opening 128 can be sent as an additional opening message to the central station 146 and/or the user portal.

If the sliding door 100 is open for a prolonged period of time during standard operation 112, for example, if the sliding door 100 is an intermediate door of the office or home, an emergency closing 150 can be performed if the sliding door 100 automatically switches from standard operation 112 to emergency operation 114 and flames, the light of a fire and/or smoke 138 are detected.

Likewise, the microphone can detect screams in the home or office. If the screams meet predefined criteria, the emergency 144 is recognized and there is a switch from standard operation 112 to emergency operation 114.

In one exemplary embodiment, the emergency 144 is recognized if pressure is applied against the inner side 126 of the closed sliding door 100. Thereby, the emergency 144 can be recognized if more than a minimum force is applied to the inner side 126. For example, the force can be measured by a force sensor of the sensor system 106. However, the force can also be detected by the drive 104. After switching to emergency operation 114, the emergency opening 128 can be triggered if there is a renewed pressing against the inner side 126.

In one exemplary embodiment, the door control device 102 activates a cooling device 152 of the sliding door 100 if a critical temperature is exceeded. The cooling device 152 cools temperature-sensitive components of the sliding door 100, such as the drive 104, the door control device 102 and/or a power supply 154 of the sliding door 100. Thereby, the critical temperature can be signaled by the sensor system 106, or alternatively or additionally by the components themselves. Here, the cooling device 152 uses compressed gas to cool the components. Due to the cooling, the sliding door 100 can withstand prolonged temperature effects from smoke 138 or fire.

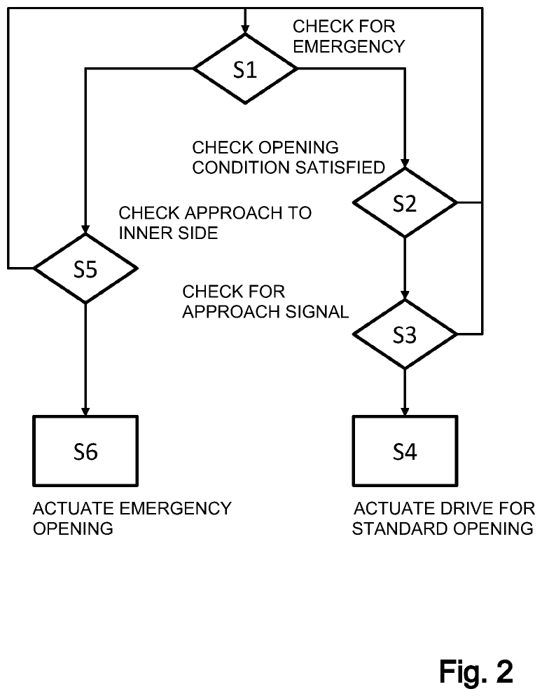

FIG. 2 shows a flowchart of a method for operating a sliding door according to an exemplary embodiment. For example, the sliding door 100 from FIG. 1 can be actuated. The sliding door can be operated during a standard operation 112 and an emergency operation 114.

In a step S1, there is a check of whether a sensor system 106 of the sliding door comprising a plurality of sensors and/or a higher-order central station 146 signals an emergency.

If the sensor system and the central station do not signal an emergency, the sliding door is operated in standard operation 112 and there is a check in step S2 as to whether the sensor system and/or the central station signal at least one opening condition 122 as satisfied.

If the sensor system and/or the central station signal the at least one opening condition as satisfied, there is a check in standard operation in a step S3 to determine whether the sensor system signals an approach 116 to the sliding door.

If the sensor system signals an approach to the sliding door, a drive 104 of the sliding door is actuated in step S4 in standard operation to perform a standard opening 120.

If, in step S2, the sensor system and/or the central station signal the at least one opening condition as not satisfied or, in step S4, the sensor system does not signal an approach to the sliding door, there is a renewed check in step S1 as to whether the sensor system and/or the central station signal the emergency.

If the sensor system and the central station signal an emergency, the sliding door is operated in emergency operation 114 and, in a step S5, irrespective of whether the sensor system or the central station signals the at least one opening condition as satisfied, there is a check of whether the sensor system signals an approach to an inner side 126 of the sliding door.

If the sensor system signals an approach at the inner side, the drive is actuated in emergency operation in a step S6 to perform an emergency opening 128.

If, in step S4, the sensor system does not signal an approach to the sliding door, the system checks again in step S1 whether the sensor system and/or the central station signal the emergency.

FIG. 1 shows a building sliding door 100 for escape and rescue routes. The automatic building sliding door can be used on escape and rescue routes. For this purpose, the door meets various requirements for certification. A multiple redundant opening concept for the sliding door is presented here. The sliding door still works after approximately 15 minutes even with fire and at approximately 600° C. at an interface and does not jam when one presses against it.

In a first step, emergency mode is activated. This can be performed through various ways, such as an emergency situation in the building, a fire, a burglary, an alarm, etc.

After activating emergency mode, all sensors on the inner side of the door are “sensitized.” If someone wants to get out, the door opens immediately.

In case of smoke, the proximity detector is switched off, since otherwise the door could be opened because of the smoke.

In the event of a power failure, a backup battery is used.

The components are protected from heat by suitable positioning. Optionally, active cooling can provide further heat protection.

If everything fails, for example, if the motor malfunctions during an emergency situation, the door can be opened mechanically as the last safety level. For this purpose, unlocking via the passive or the active door locking system from the inner side is possible at any time. Mechanical emergency opening and seals against smoke and fire are possible due to the special structure of the door, with panels that are pressed into the wall cutouts from the inside.

It is noted that two other patent applications, which also relate to sliding doors, are being filed by the applicant on the same day as the present patent application. Designs of the sliding doors described therein and their methods of operation may also be used, as appropriate, in the same or similar manner in embodiments of the sliding door described herein. The contents of the two other patent applications, WO 2022/243091 A1 (EP21173992.5) and WO 2022/243039 A1 (EP21173993.3), are incorporated herein by reference in their entirety.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A sliding door for use as an escape and rescue door, the sliding door comprising:
a drive adapted to open and close the sliding door;
a door control device adapted to actuate the drive;
a sensor system including a plurality of sensors generating sensor signals to the door control device, the sensor signals representing operating conditions related to operation of the sliding door;
wherein the door control device actuates the drive to perform a standard opening of the sliding door during a standard operation when at least one of the sensor signals indicates an opening condition as satisfied and another of the sensor signals indicates an approach to the sliding door; and
wherein the door control device switches from the standard operation to an emergency operation when the sensor system and/or a central station signals an emergency, the door control device then actuating the drive to perform an emergency opening in the emergency operation irrespective of whether the sensor system and/or the central station signals that at least one opening condition is satisfied, and when at least one sensor of the sensor system generates a sensor signal indicating an approach to an inner side of the sliding door.

17. The sliding door according to claim 16 wherein the door control device switches to the emergency operation when the sensor system generates a sensor signal indicating flames and/or smoke adjacent to the inner side of the sliding door as the emergency.

18. The sliding door according to claim 17 wherein the door control device actuates the drive to perform an emergency closing when the sliding door is open and the sensor system generates the sensor signal indicating flames and/or smoke adjacent to the inner side of the sliding door and generates another sensor signal indicating no approach to the inner side of the sliding door.

19. The sliding door according to claim 16 wherein the door control device does not actuate the drive to open the sliding door when the sensor system generates a sensor signal indicating smoke adjacent to the inner side of the sliding door and generates exclusively by a proximity sensor of the sensor system the sensor signal indicating an approach to the inner side of the sliding door.

20. The sliding door according to claim 16 wherein the door control device actuates an operating element arranged on the inner side of the sliding door during the emergency operation and actuates the drive when the operating element signals an operation.

21. The sliding door according to claim 20 wherein the operating element moves out of a plane of the sliding door upon actuation.

22. The sliding door according to claim 16 wherein the door control device actuates the drive to perform an emergency closing of the sliding door after a predefined opening time following the emergency opening.

23. The sliding door according to claim 16 wherein the door control device switches to the emergency operation when an application of force on the inner side of the sliding door greater than a predetermined threshold value is signaled by the sensor system, the door control device actuating the drive to perform the emergency opening in the emergency operation when a renewed or prolonged application of force to the inner side of the sliding door is signaled by the sensor system.

24. The sliding door according to claim 23 wherein the door control device switches to the emergency operation and/or actuates the drive to perform the emergency opening when the drive signals the application of force.

25. The sliding door according to claim 16 wherein the door control device switches to the emergency operation when the sensor system signals a continuous loud screaming on the inner side of the sliding door or when the sensor system signals a temperature on the inner side of the sliding door that is greater than a predetermined temperature threshold value.

26. The sliding door according to claim 16 wherein the door control device increases a sensitivity of the sensor system from a standard sensitivity in the standard operation to an emergency sensitivity when in the emergency operation.

27. The sliding door according to claim 16 wherein the door control device actuates the drive to perform the emergency opening in the emergency operation when the central station signals an emergency opening command.

28. The sliding door according to claim 16 wherein the sliding door includes a cooling device cooling components of the sliding door, the door control device activating the cooling device in the emergency operation when the sensor system signals a temperature on the inner side of the sliding door is greater than a predetermined temperature threshold value.

29. The sliding door according to claim 16 wherein the sliding door includes an emergency power supply providing electrical power to components of the sliding door after a power failure of a power source of the sliding door.

30. A method for operating a sliding door as an escape and rescue door, the method comprising the steps of:
operating the sliding door according to claim 16 during the standard operation by actuating the drive in response to the sensor signals from the sensor system to perform a standard opening of the sliding door when the sensor system signals at least one opening condition as satisfied and signals an approach to the sliding door; and
switching to the emergency operation when the sensor system or the central station signals an emergency, wherein the drive is actuated to perform an emergency opening in the emergency operation irrespective of whether the sensor system or the central station signals the at least one opening condition as satisfied, when at least one sensor of the sensor system signals an approach to the inner side of the sliding door.

31. The method according to claim 30 including increasing a sensitivity of the sensor system from a standard sensitivity in the standard operation to an emergency sensitivity in the emergency operation.
